(19) United States
(12) Patent Application Publication
(10) Pub. No.: US 2025/0260777 A1
(43) Pub. Date: Aug. 14, 2025

(54) IMAGE READING APPARATUS AND IMAGE FORMING SYSTEM

(71) Applicant: CANON KABUSHIKI KAISHA, Tokyo (JP)

(72) Inventors: KAORU HAMADA, Chiba (JP); SATOSHI OKAWA, Ibaraki (JP)

(21) Appl. No.: 19/049,569

(22) Filed: Feb. 10, 2025

(30) Foreign Application Priority Data
Feb. 14, 2024 (JP) 2024-020324

(51) Int. Cl. H04N 1/401; H04N 1/00; H04N 1/053

(52) U.S. Cl. CPC H04N 1/401; H04N 1/00689; H04N 1/00737; H04N 1/00774; H04N 1/00798; H04N 1/053; H04N 2201/0081

(57) ABSTRACT

Disclosed is an image reading apparatus including a reference member, a reader configured to read one of an original or the reference member, a mover configured to move the reader to a first region in which the original is read and a second region in which the reference member is read in a conveying direction of the original, and at least one processor configured to perform shading correction, wherein the at least one processor is configured to control the reader to move from outside of the second region to inside of the second region in the conveying direction to perform a first reading operation of reading the reference member within the second region.

### BACKGROUND OF THE INVENTION

### Field of the Invention

The present disclosure relates to an image reading apparatus for reading an image from an original.

### Description of the Related Art

An image reading apparatus can read an original by “fixed reading” in which an original placed on a platen is read or “flow reading” in which an original conveyed by an automatic document feeder (hereinafter abbreviated as “ADF”) is read. In the flow reading, a plurality of originals can be read successively. The image reading apparatus includes a reading unit in order to read the original. In the fixed reading, while the reading unit is moved in one direction below the platen, the reading unit reads the original one line by one line, assuming a direction orthogonal to the moving direction as one line. In the flow reading, the position of the reading unit is fixed, and the reading unit reads the original conveyed by the ADF to pass through a reading position one line by one line, assuming a direction orthogonal to the conveying direction of the original as one line. The direction of the one line is a main scanning direction, and the direction in which the reading unit moves or the conveying direction of the original is a sub-scanning direction.

The image reading apparatus is connected to an image forming apparatus to form a copying machine. There is a demand for the copying machine to reduce a first copy output time which is a time required from reading start of one original to output of a copied product.

The image reading apparatus performs shading processing as advance preparation before reading the original. The shading processing is processing of generating shading correction data for matching a reading result (reading data) of a white reference member with reference data. The shading correction data is a correction value for reading pixels in the main scanning direction of the original at a uniform density regardless of sensitivity unevenness of a reading sensor or light amount unevenness of a light source. With the shading correction being performed through use of the shading correction data, an image can be accurately read. The shading correction is performed by, for example, adjusting a light emitting amount of the light source or sensitivity of a light receiving element of the reading unit or correcting the read image.

In the shading processing, in a case where a foreign matter such as dust adheres to the white reference member, accurate shading correction data cannot be obtained. For example, in a case where a foreign matter adheres to the white reference member, reading data that is supposed to be a constant value after the shading correction becomes an abnormal value at the position of the foreign matter. The shading correction data generated based on such reading data has an abnormal value only at the position of the foreign matter. In a case where the shading correction is performed through use of such shading correction data, a reading image of the original may have, for example, a white streak caused at the position of the foreign matter. In order to address this issue, in U.S. Pat. No. 6,801,670, the position of the foreign matter is identified based on results of reading the white reference member a plurality of times at different positions in the sub-scanning direction, and the data of the position of the foreign matter in the shading correction data is corrected. The shading correction can be performed in accordance with the results acquired in one movement of the reading unit, however, there is further room for improvement in the acquisition of the results for shading correction.

### SUMMARY OF THE INVENTION

An image reading apparatus according to one embodiment of the present disclosure includes a reference member, a reader configured to read one of an original or the reference member, a mover configured to move the reader to a first region in which the original is read and a second region in which the reference member is read in a conveying direction of the original, and at least one processor configured to perform shading correction, wherein the at least one processor is configured to control the reader to move from outside of the second region to inside of the second region in the conveying direction to perform a first reading operation of reading the reference member within the second region, control the reader to move, after the first reading operation is performed, from the outside of the second region to the inside of the second region again and cause the reader to perform a second reading operation of reading the reference member within the second region, and perform the shading correction using a first reading result read in the first reading operation and a second reading result read in the second reading operation.

An image forming system according to another embodiment of the present disclosure includes an image reading apparatus, and an image forming apparatus configured to form an image onto a sheet based on image data generated by performing shading correction of a reading result of the original by the image reading apparatus, wherein the image reading apparatus includes a reference member, a reader configured to read one of an original or the reference member, a mover configured to move the reader to a first region in which the original is read and a second region in which the reference member is read in a conveying direction of the original, and at least one processor configured to perform the shading correction, and wherein the at least one processor is configured to control the reader to move from outside of the second region to inside of the second region in the conveying direction to perform a first reading operation of reading the reference member within the second region, control the reader to move, after the first reading operation is performed, from the outside of the second region to the inside of the second region again and cause the reader to perform a second reading operation of reading the reference member within the second region, and perform the shading correction using a first reading result read in the first reading operation and a second reading result read in the second reading operation.

Further features of the present invention will become apparent from the following description of exemplary embodiments (with reference to the attached drawings).

### BRIEF DESCRIPTION OF THE DRAWINGS

FIG. 1 is an external appearance perspective view of an automatic original reading apparatus.

FIG. 2 is an explanatory view of an operation unit.

FIG. 3 is an internal configuration view of the automatic original reading apparatus.

FIG. 4 is a configuration diagram of a control system.

FIG. 5A, FIG. 5B, FIG. 5C, FIG. 5D, and FIG. 5E are explanatory views of shading processing.

FIG. 6A and FIG. 6B are explanatory graphs of the shading processing.

FIG. 7A, FIG. 7B, and FIG. 7C are explanatory diagrams of an influence caused in a case where a foreign matter adheres to a white reference member.

FIG. 8 is a flow chart for illustrating abnormal pixel detection processing.

FIG. 9A, FIG. 9B, and FIG. 9C are explanatory views of abnormal pixel detection.

FIG. 10 is a flow chart for illustrating processing of correcting an abnormal pixel.

FIG. 11 is an explanatory view of a result of abnormal pixel correction.

FIG. 12 is a flow chart for illustrating processing of reading the original.

FIG. 13 is a flow chart for illustrating abnormal pixel detection processing.

FIG. 14 is an explanatory view of abnormal pixel detection.

FIG. 15 is a flow chart for illustrating abnormal pixel correction processing.

FIG. 16 is a flow chart for illustrating processing of reading the original.

FIG. 17 is an explanatory view of sensors provided below a platen.

FIG. 18 is a flow chart for illustrating processing of reading the original.

FIG. 19 is a flow chart for illustrating processing of reading the original.

FIG. 20 is a flow chart for illustrating processing of reading the original.

FIG. 21 is a configuration view of an image forming system.

### DESCRIPTION OF THE EMBODIMENTS

Now, preferred embodiments of the present disclosure are described with reference to the attached drawings.

### First Embodiment

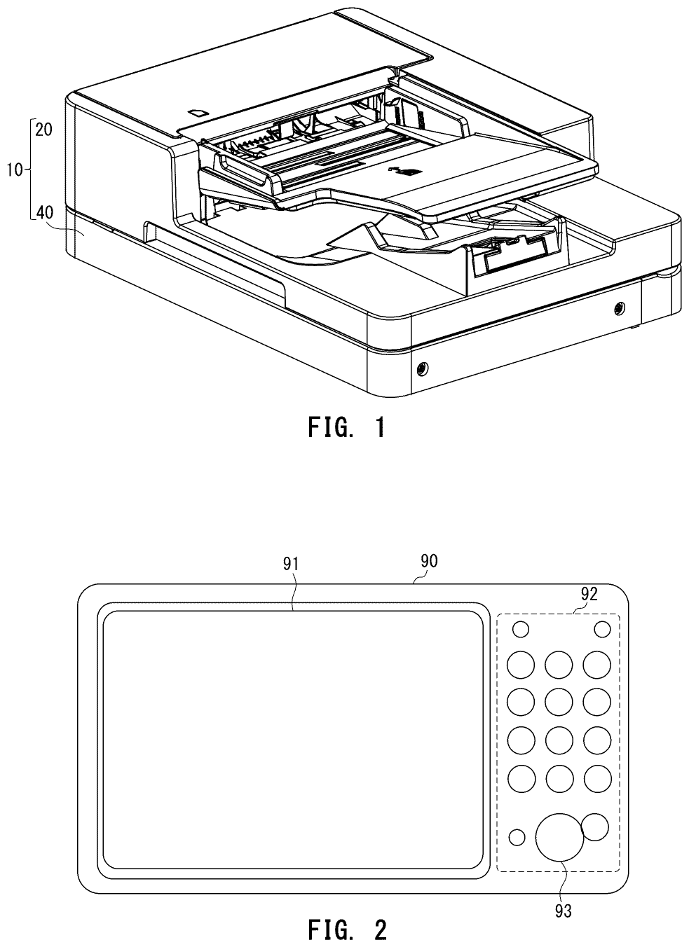

FIG. 1 is an external appearance perspective view of an automatic original reading apparatus including an image reading apparatus of a first embodiment of the present disclosure. An automatic original reading apparatus 10 includes an image reading apparatus (hereinafter referred to as “reader 40”) for reading an original, and an ADF 20 for automatically conveying the original to a reading position at which the original is read by the reader 40. The ADF 20 functions as a sheet conveying device for conveying a sheet-shaped original to the reader 40.

The automatic original reading apparatus 10 includes an operation unit. FIG. 2 is an explanatory view of the operation unit. An operation unit 90 is a user interface including an input interface and an output interface. The input interface is an operation key group 92 including a start key 93 in FIG. 2. The input interface may include, for example, a touch panel in addition thereto. The output interface is a display unit 91 in FIG. 2. The output interface may include, for example, a speaker in addition thereto.

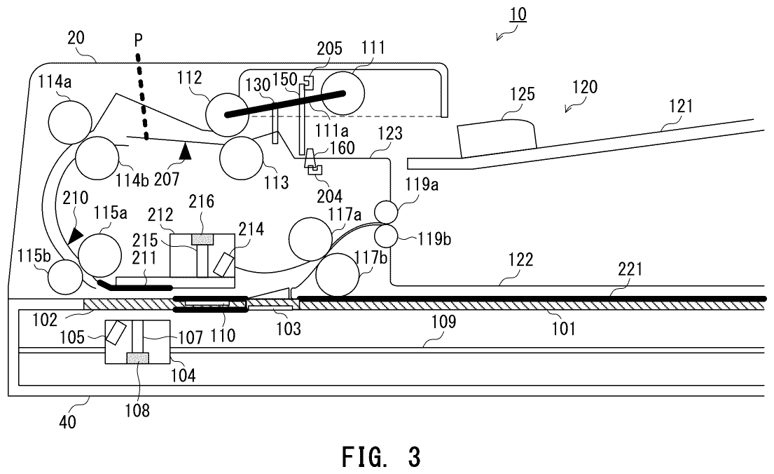

FIG. 3 is an internal configuration view of the automatic original reading apparatus 10. The reader 40 includes a platen 101 between the reader 40 and the ADF 20. The ADF 20 is turnably supported to the reader 40 by a hinge (not shown) so that the ADF 20 is openable and closable with respect to the platen 101. The reader 40 and the ADF 20 each include a reading unit for reading an original. The reader 40 includes a front surface reading unit 104 for reading a first surface (the first surface is hereinafter also referred to as “front surface”) of the original. The ADF 20 includes a back surface reading unit 212 for reading a second surface (the second surface is hereinafter also referred to as “back surface”) which is different from the first surface of the original. The original may be white paper, or the original may have an image formed on one surface or both surfaces thereof.

The ADF 20 includes an original tray 121 on which originals are to be stacked, and a discharge tray 122 to which the original subjected to reading is to be discharged. The original tray 121 forms a sheet stacking unit 120 together with a conveyance lower guide 123 of the ADF 20. The original tray 121 includes, on an original stacking surface, width restricting plates 125 which are movable in a width direction orthogonal to a conveying direction of the original. The width restricting plates 125 restrict the position in the width direction of the original placed on the original tray 121. Two width restricting plates 125 are provided in the width direction, and the two width restricting plates 125 sandwich the original placed on the original tray 121.

The two width restricting plates 125 use an interlocking mechanism (not shown), for example, a rack-and-pinion mechanism arranged in the original tray 121 so that movement of one of the two width restricting plates 125 causes the other of the two width restricting plates 125 to move in association therewith. In the first embodiment, a conveyance center of the original is at a middle in the width direction, and the two width restricting plates 125 are configured to come close to or separate from the middle in the width direction. In this manner, the conveyance center of the original is always at the same position regardless of the size of the original. Further, through measurement of an interval between the two width restricting plates 125, a size in the width direction of the original placed on the original tray 121 can be detected.

The ADF 20 includes, in order to feed the original from the original tray 121, a pick-up roller 111 serving as a conveyance rotary member, and a separation drive roller 112 and a retard roller 113 forming a separation roller pair. The ADF 20 includes, in order to convey the fed original, a registration roller pair 114a and 114b, a read roller pair 115a and 115b, a conveyance roller pair 117a and 117b, and a discharge roller pair 119a and 119b.

A first original presence/absence detection sensor 204 and a second original presence/absence detection sensor 205 are provided between the pick-up roller 111 and the separation roller pair. A post-separation sensor 207 is provided in a conveyance path between the separation roller pair and the registration roller pair 114a and 114b. A read sensor 210 is provided in a conveyance path between the registration roller pair 114a and 114b and the read roller pair 115a and 115b. The back surface reading unit 212 is provided in a conveyance path between the read roller pair 115a and 115b and the conveyance roller pair 117a and 117b.

The reader 40 includes a front surface reading glass 102 on the same surface as the platen 101, and includes the front surface reading unit 104 inside of the reader 40. The front surface reading glass 102 is provided with a front-surface white reference member 103 directed inward of the reader 40, and is also provided with a back-surface white reference member 110 directed outward of the reader 40. The front-surface white reference member 103 and the back-surface white reference member 110 are used for shading processing. At least the front-surface white reference member 103 uses an inexpensive product employing a sheet having unevenness on its surface.

Although details are described later, shading correction is performed based on a reading result of the front-surface white reference member 103 obtained by the front surface reading unit 104. However, the front-surface white reference member 103 has unevenness on its surface, and hence there is a possibility that accurate shading correction data cannot be acquired. Variations in shading correction data due to unevenness cause variations in luminance of a reading image in a case where the original is read. Variations in luminance due to unevenness of a sheet surface are smaller than variations in luminance due to a foreign matter. Accordingly, it is difficult to detect and correct the unevenness of the sheet surface as in the case of the foreign matter.

Shading correction data that is suppressed in influence of a foreign matter or unevenness can be acquired based on a plurality of pieces of reading data obtained by reading the front-surface white reference member 103 a plurality of times. However, the variations in luminance due to the foreign matter are large, and hence, in order to suppress the influence of the foreign matter, it is required to take a large reading region (shading region) of the front-surface white reference member 103.

The front surface reading unit 104 is arranged on a guide 109, and is movable along the guide 109. The front surface reading unit 104 is positioned right below the front surface reading glass 102 in a case where the front surface reading unit 104 reads the original conveyed by the ADF 20, and moves along the guide 109 in a case where the front surface reading unit 104 reads the original placed on the platen 101.

In the first embodiment, an operation mode of reading the original conveyed by the ADF 20 is referred to as “flow reading mode,” and an operation mode of reading the original placed on the platen 101 is referred to as “fixed reading mode.” The flow reading mode is set in a case where the first original presence/absence detection sensor 204 detects an original stacked on the original tray 121 or in a case where a user gives an explicit instruction through the operation unit 90 or the like. The fixed reading mode is set in a case where the original placed on the platen 101 is detected or in a case where the user gives an explicit instruction through the operation unit 90.

An operation of conveying the original by the ADF 20 is described. The pick-up roller 111 is provided so as to be rockable by an arm 111a. The arm 111a is driven to be raised and lowered so that the pick-up roller 111 is brought into abutment against or separated from the uppermost original of a bundle of originals stacked on the original tray 121. The arm 111a is provided in conjunction with a locking mechanism for locking a restriction plate 130 to be brought into abutment against an edge portion of the original. This locking mechanism locks the restriction plate 130 at a position for restricting a leading edge position of the original, under a state in which the pick-up roller 111 is raised. Further, the locking mechanism cancels the locking of the restriction plate 130 under a state in which the pick-up roller 111 is lowered so that passage of the original is allowed.

On the upstream side with respect to the restriction plate 130 in the conveying direction of the original, a detection member 160 of the first original presence/absence detection sensor 204 and a detection member 150 of the second original presence/absence detection sensor 205 are arranged side by side in the width direction. The detection member 160 and the detection member 150 are arranged on the downstream side in the conveying direction of the original with respect to the pick-up roller 111, specifically, on the downstream side in the conveying direction with respect to the position at which the pick-up roller 111 is lowered to abut against the original. The first original presence/absence detection sensor 204 outputs an on-signal in a case where the detection member 160 is pressed downward and turned by the original. The second original presence/absence detection sensor 205 outputs an on-signal in a case where the detection member 150 is pressed upward and turned by the original. The presence or absence of the original on the original tray 121 is determined based on the signals output from the first original presence/absence detection sensor 204 and the second original presence/absence detection sensor 205.

The original fed by the pick-up roller 111 is separated one by one and conveyed by the separation drive roller 112 and the retard roller 113. A torque limiter is arranged in a rotation support structure of the retard roller 113. The retard roller 113 follows the separation drive roller 112 in a case where the number of fed originals is one, but does not rotate in a case where the number of fed originals is two or more. In this manner, the originals are separated one by one. The retard roller 113 may be driven in a direction opposite to the conveying direction. At the time of the fixed reading mode, simultaneously with the lowering of the pick-up roller 111, the front surface reading unit 104 moves to a position right below a conveyance guide plate 211 in order to read the conveyed original.

A leading edge and a trailing edge of the original that has passed through the separation roller pair are detected by the post-separation sensor 207. Detection results obtained by the post-separation sensor 207 become references of a raising or lowering timing and drive start and drive stop timings of the pick-up roller 111. The pick-up roller 111 and the separation drive roller 112 are driven by the same drive source.

The registration roller pair 114a and 114b corrects skew feeding of the original. The original subjected to skew feeding correction by the registration roller pair 114a and 114b is conveyed by the read roller pair 115a and 115b toward the front surface reading glass 102. The drive timings of the registration roller pair 114a and 114b and the read roller pair 115a and 115b are controlled based on the detection results obtained by the post-separation sensor 207. The conveyance guide plate 211 is arranged so as to be opposed to the front surface reading glass 102. The conveyance guide plate 211 guides the original so as to prevent the original passing between the conveyance guide plate 211 and the front surface reading glass 102 from coming off from the front surface reading glass 102. The position of the conveyance guide plate 211 becomes a reading position of reading the original by the front surface reading unit 104. The registration roller pair 114a and 114b and the read roller pair 115a and 115b are driven by the same drive source.

In a case where one surface of the original is to be read, an image on the front surface of the original is read by the front surface reading unit 104 through the front surface reading glass 102. The front surface reading unit 104 includes a light emitting diode (LED) 105 serving as a light source, a lens array 107, and a reading sensor 108 which is a line sensor.

In the front surface reading unit 104, the LED 105 irradiates the front surface (reading surface) of the original with light. The reflected light from the front surface of the original passes through the lens array 107 so as to be received by the reading sensor 108. The reading sensor 108 includes a plurality of light receiving elements arrayed on a straight line, and each light receiving element receives the reflected light. Each light receiving element photoelectrically converts the reflected light so as to generate and output image data as a reading result of the original. The plurality of light receiving elements are arrayed in a direction orthogonal to the conveying direction of the original, and perform photoelectrical conversion for each line. The LED 105 linearly applies light in an array direction of the light receiving elements. Because of this configuration, the direction orthogonal to the conveying direction of the original is the main scanning direction, and the conveying direction of the original is the sub-scanning direction.

The original whose front surface has been read by the front surface reading unit 104 is discharged to the discharge tray 122 by the conveyance roller pair 117a and 117b and the discharge roller pair 119a and 119b. The conveyance roller pair 117a and 117b and the discharge roller pair 119a and 119b are driven by the same drive source.

In a case where both surfaces of the original are to be read, the image on the front surface of the original is read by the front surface reading unit 104, and the image on the back surface of the original is read by the back surface reading unit 212. The back surface reading unit 212 has a configuration similar to that of the front surface reading unit 104, and includes an LED 214 serving as a light source, a lens array 215, and a reading sensor 216 which is a line sensor. The back surface reading unit 212 reads the back surface of the original whose front surface has been read by the front surface reading unit 104. The reading operation of the original performed by the back surface reading unit 212 is similar to that performed by the front surface reading unit 104. Further, the main scanning direction and the sub-scanning direction are also the same.

In the fixed reading mode, which does not use the ADF 20, the original is placed on the platen 101 with its reading surface being directed toward the reader 40 side. In this case, the original on the platen 101 does not move, and the front surface reading unit 104 reads the original while moving right below the platen 101 along the guide 109. The reading operation performed by the front surface reading unit 104 itself is similar to that at the time of the flow reading mode. In the fixed reading mode, the moving direction of the front surface reading unit 104 is the sub-scanning direction, and a direction orthogonal to the moving direction is the main scanning direction.

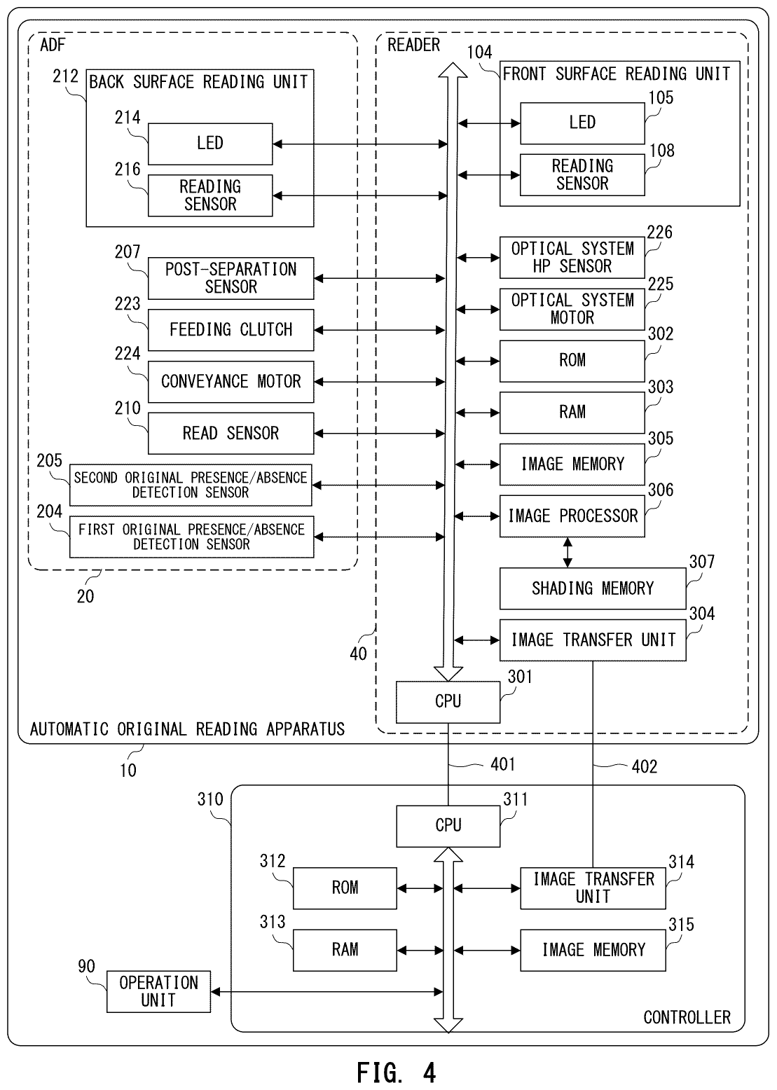

FIG. 4 is a configuration diagram of a control system for controlling the operation of the automatic original reading apparatus 10. The control system includes a controller 310 and a configuration provided in a section shown as the reader 40. The controller 310 may be provided in the automatic original reading apparatus 10, but, in a case where the automatic original reading apparatus 10 is connected to an external apparatus, for example, an image forming apparatus, the controller 310 may be provided on the image forming apparatus side. Through connection to the automatic original reading apparatus 10, such an image forming apparatus forms, for example, a copying machine, a facsimile apparatus, a multifunction machine, or a multifunction peripheral (MFP).

The configuration provided in the section of the reader 40 is an information processing device including a central processing unit (CPU) 301, a read only memory (ROM) 302, and a random access memory (RAM) 303. In the section of the reader 40, an image memory 305, an image processor 306, a shading memory 307, and an image transfer unit 304 are also provided as the control system. The image transfer unit 304 is connected to the controller 310 via an image transfer line 402 so that communication is allowed therebetween. Further, the reader 40 includes an optical system HP sensor 226 and an optical system motor 225 in addition to the configuration described with reference to FIG. 3. The ADF 20 includes a feeding clutch 223 and a conveyance motor 224 in addition to the configuration described with reference to FIG. 3.

The CPU 301 executes a computer program stored in the ROM 302 to control the operations of the reader 40 and the ADF 20. The RAM 303 provides a work area used in a case where the CPU 301 executes processing. The CPU 301 is connected to each component of the reader 40 and the ADF 20 via a bus so that communication is allowed therebetween. The CPU 301 is connected to the controller 310 via a communication line 401 so that communication is allowed therebetween.

The CPU 301 drives and controls the conveyance motor 224 for driving each of the above-mentioned rollers for conveying the original, in order to implement an original conveyance function by the ADF 20. The conveyance motor 224 is connected to the pick-up roller 111 and the separation drive roller 112 via the feeding clutch 223. In a case where the feeding clutch 223 is disconnected, the conveyance of the original can be stopped at a position P (see FIG. 3) right before arrival to the registration roller pair 114a and 114b. Further, the conveyance motor 224 is connected to the registration roller pair 114a and 114b, the read roller pair 115a and 115b, the conveyance roller pair 117a and 117b, and the discharge roller pair 119a and 119b so as to drive those roller pairs.

The conveyance motor 224 is a pulse motor. The CPU 301 controls the number of drive pulses to drive and control the conveyance motor 224. The number of drive pulses has a correlation with a conveying distance of the original during conveyance. Accordingly, the CPU 301 controls each load based on the conveying distance derived from the number of drive pulses to perform conveyance of the original.

The CPU 301 detects the presence or absence of the original on the original tray 121 based on detection results of the first original presence/absence detection sensor 204 and the second original presence/absence detection sensor 205. The CPU 301 detects the position of the original conveyed through the conveyance path based on the detection results of the post-separation sensor 207 and the read sensor 210.

The optical system motor 225 is a drive source for moving the front surface reading unit 104 in the sub-scanning direction along the guide 109. The optical system motor 225 is driven and controlled by the CPU 301. The optical system HP sensor 226 is a sensor for detecting that the front surface reading unit 104 is positioned at a home position (HP).

The front surface reading unit 104 includes the LED 105 and the reading sensor 108 as described above. In the front surface reading unit 104, the reading sensor 108 receives the reflected light of the light applied from the LED 105 to the conveyed original so that image data which is a reading result is generated. The back surface reading unit 212 includes the LED 214 and the reading sensor 216 as described above. In the back surface reading unit 212, the reading sensor 216 receives the reflected light of the light applied from the LED 214 to the conveyed original so that image data which is a reading result is generated. The image data output from each of the front surface reading unit 104 and the back surface reading unit 212 is temporarily stored in the image memory 305. The image data represents a reading image.

The processing of reading the original by the front surface reading unit 104 and the back surface reading unit 212 is controlled by the CPU 301. The CPU 301 causes the front surface reading unit 104 and the back surface reading unit 212 to perform the processing of reading the original in response to detection of the original by the read sensor 210.

The image processor 306 corrects reading data (reading image) stored in the image memory 305 by predetermined image processing on the reading data. The shading memory 307 is connected to the image processor 306, and holds shading correction data to be described later. The CPU 301 can read out data held in the shading memory 307 and write data via the image processor 306. The image transfer unit 304 transfers the image data subjected to image processing by the image processor 306 to the controller 310 via the image transfer line 402.

The controller 310 controls the entire operation of an image reading system including the reader 40 and the ADF 20. The controller 310 includes a CPU 311, a ROM 312, a RAM 313, an image transfer unit 314, and an image memory 315. Those components are connected to each other via a bus so that communication is allowed therebetween. The operation unit 90 is also connected to this bus.

The CPU 311 executes a computer program stored in the ROM 312 to control the operation of the controller 310. The CPU 311 receives an instruction or the like input through the operation unit 90. The CPU 311 displays a message, a read image, or the like on the display unit 91 of the operation unit 90. The RAM 313 provides a work area used in a case where the CPU 311 executes processing. The image transfer unit 314 acquires the image data from the image transfer unit 304 of the reader 40 via the image transfer line 402 and stores the image data into the image memory 315.

The CPU 311 performs image reading control for the automatic original reading apparatus 10 in cooperation with the CPU 301. Accordingly, the CPU 311 performs transmission and reception of control data such as an instruction relating to the image reading control via the communication line 401 between the CPU 311 and the CPU 301.

For example, the CPU 311 acquires an instruction to start an image reading job from the operation unit 90, and transmits a reading start instruction to the CPU 301. The instruction to start the image reading job includes information such as an instruction of black and white reading or color reading, a reading resolution, a reading original size, and an image reading job start instruction. The reading start instruction includes control information such as an original feeding start instruction and an original reading instruction. The original feeding start instruction includes information on the reading resolution, and the original reading instruction includes information on the reading original size. Further, the CPU 311 acquires information indicating the state of the automatic original reading apparatus 10 from the CPU 301, and causes the operation unit 90 to display a message to a user corresponding to the state of the apparatus.

### Shading Correction

The front-surface white reference member 103 and the back-surface white reference member 110 are white reference plates for use in creating correction data for correcting the white level by shading. The front-surface white reference member 103 is used for generation of the shading correction data for the front surface reading unit 104. The back-surface white reference member 110 is used for generation of the shading correction data for the back surface reading unit 212. Through image processing on the reading result (reading data) of the front-surface white reference member 103 obtained by the front surface reading unit 104, the shading correction data for the front surface reading unit 104 is generated. Through image processing on the reading result (reading data) of the back-surface white reference member 110 obtained by the back surface reading unit 212, the shading correction data for the back surface reading unit 212 is generated. The shading correction data is generated before the original is read.

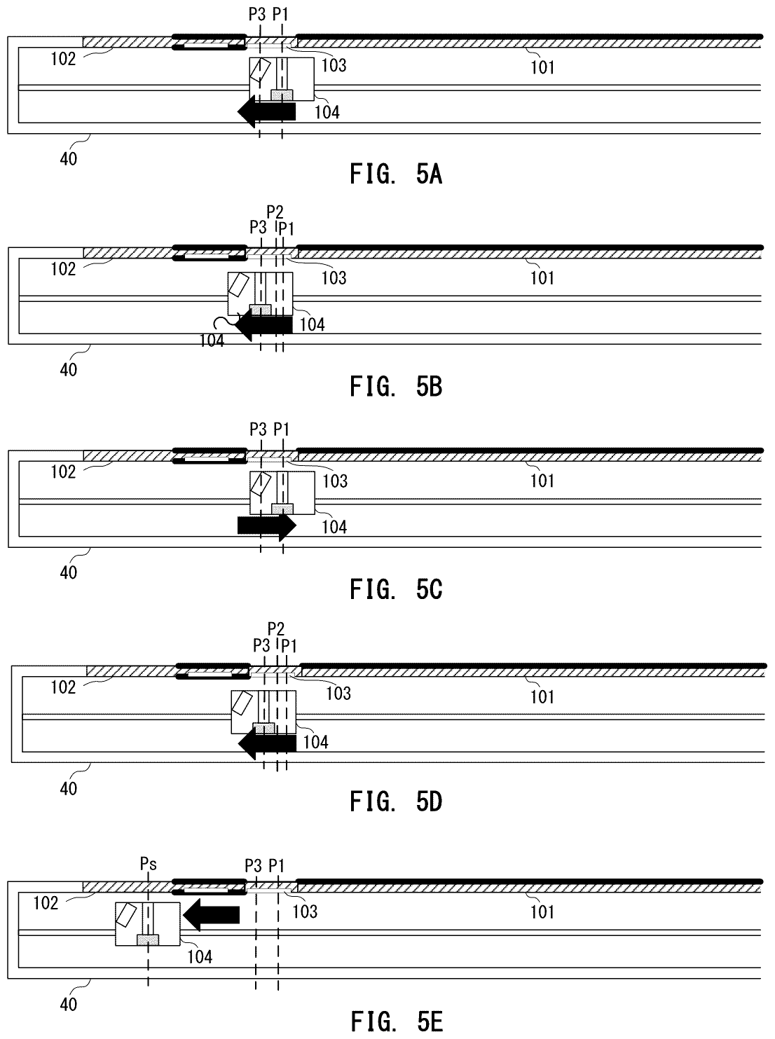

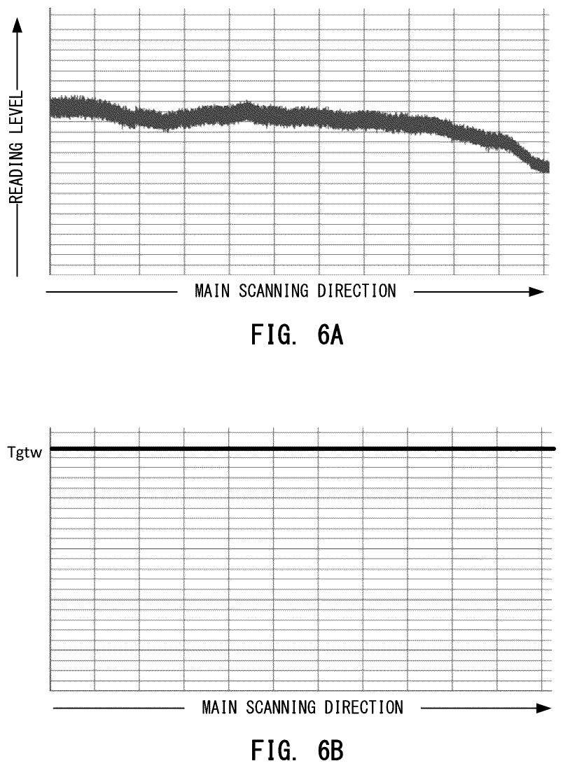

FIG. 5A to FIG. 5E and FIG. 6A and FIG. 6B are explanatory diagrams of the shading processing of the front surface reading unit 104. FIG. 5A shows a state in which the front surface reading unit 104 starts moving from a position P1 which is the home position. That is, the front surface reading unit 104 moves from outside of a region for reading the front-surface white reference member 103 to inside of the region. FIG. 5B shows a state in which the front surface reading unit 104 has moved from the position P1 via a position P2 to a position P3. FIG. 5C shows a state in which the front surface reading unit 104 has moved from the position P3 via the position P2 to the position P1. FIG. 5D shows a state in which the front surface reading unit 104 has moved from the position P1 via the position P2 to the position P3. FIG. 5E shows a state in which the front surface reading unit 104 has moved to a reading start position Ps. In a case where the flow reading is performed in the flow reading mode, the front surface reading unit 104 reads the original at the reading start position Ps. In a case where the fixed reading is performed in the fixed reading mode, the front surface reading unit 104 reads the original while moving from the reading start position Ps in the sub-scanning direction. That is, the front surface reading unit 104 moves from outside of a region for reading the original to inside of the region.

In the shading processing of the front surface reading unit 104, the front surface reading unit 104 reads the front-surface white reference member 103 while moving from the position P1 to the position P3 right below the front-surface white reference member 103. FIG. 6A is an exemplary graph of a reading result of one line. FIG. 6A shows a reading level (for example, a luminance value) of each position (each pixel) in the main scanning direction. In the shading processing, a correction coefficient of each pixel is derived so that the reading level of each pixel as in FIG. 6A is corrected to a predetermined white level Tgtw as shown in FIG. 6B. This correction coefficient is the front-surface shading correction data, and is stored in the shading memory 307.

The back surface reading unit 212 is fixed to the ADF 20, and reads the back-surface white reference member 110 without moving unlike the front surface reading unit 104 at the time of the shading processing. The correction coefficient of each pixel is derived based on the reading result (reading level) of the back-surface white reference member 110 obtained by the back surface reading unit 212, similarly to the front surface. This correction coefficient is the back-surface shading correction data, and is stored in the shading memory 307.

The shading correction data is formed of pieces of data (correction values) corresponding to the number of pixels in the main scanning direction for each of the three primary colors (red, green, and blue) of the light source. In a case where the original is read, the image processor 306 generates image data by correcting the reading image (reading data) of one line through use of the shading correction data stored in the shading memory 307, for example, every time the original is read by one line. The image processor 306 stores the image data generated through correction into the image memory 305.

### Abnormal Pixel Detection

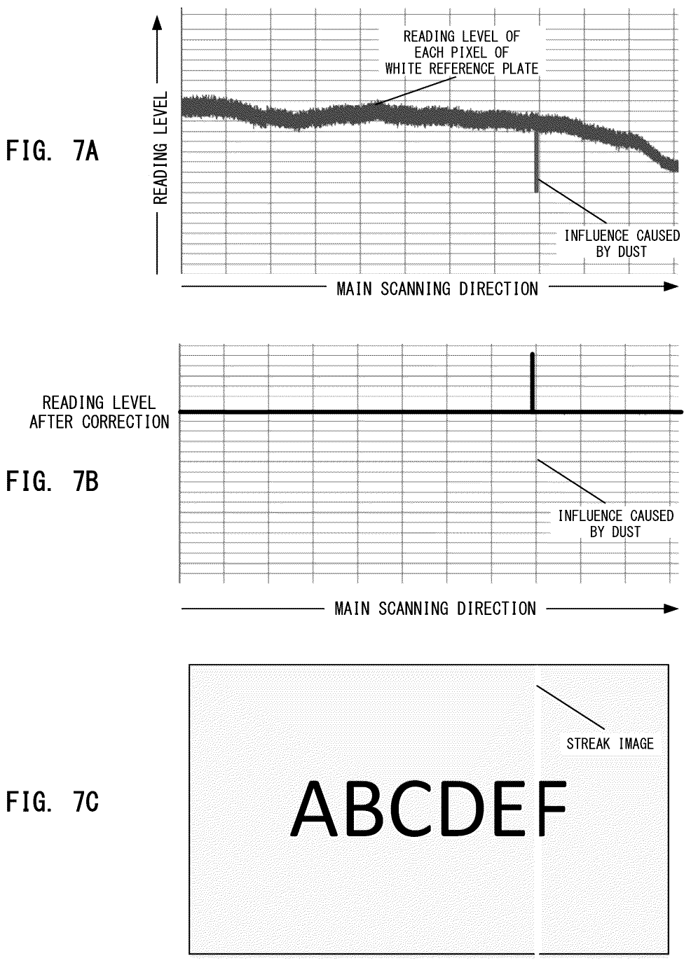

In a case where a foreign matter such as dust adheres to the front-surface white reference member 103 or the back-surface white reference member 110, an abnormal value is included in the reading level of the reading result, and thus accurate shading correction data cannot be obtained. FIG. 7A to FIG. 7C are explanatory views of the influence caused in a case where a foreign matter adheres to the white reference member.

FIG. 7A shows the reading level of each position (each pixel) in the main scanning direction which is the reading result of the white reference member having a foreign matter (dust) adhering thereto. There is a pixel having an abnormally lower reading level as compared to other pixels due to the influence of the dust. FIG. 7B shows a reading level in a case in which the reading result of the white reference member without adhesion of dust is corrected by the shading correction data obtained from the reading result of FIG. 7A. The reading level of the pixel at the position of adhesion of dust is abnormally higher than the reading levels of other pixels. FIG. 7C shows a copied image obtained after shading correction is performed through use of such shading correction data at the time of copying the original. A white streak image is generated at the position of the dust.

A position (pixel) in the main scanning direction that has an abnormal reading result in a case where a foreign matter adheres to the white reference member as described above is referred to as “abnormal pixel.” Description is given of abnormal pixel detection performed in a case where a foreign matter adheres to the front-surface white reference member 103. In the first embodiment, the abnormal pixel detection for the front-surface white reference member 103 is performed by detecting a pixel having an abnormal value from the shading correction data (shading correction coefficient). The shading correction data of the detected abnormal pixel is corrected by being interpolated through use of shading correction data of a pixel adjacent to the abnormal pixel.

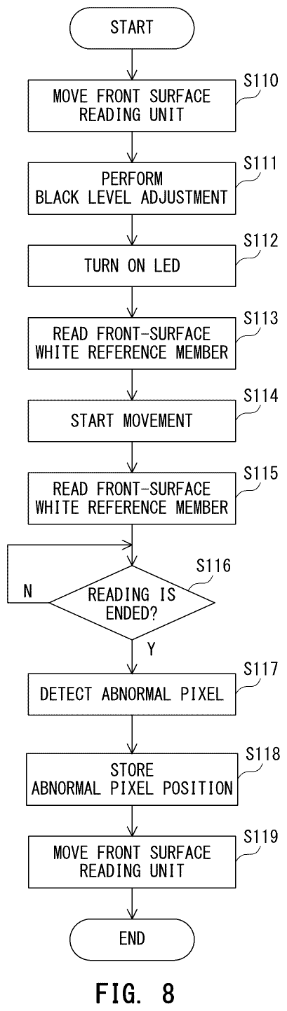

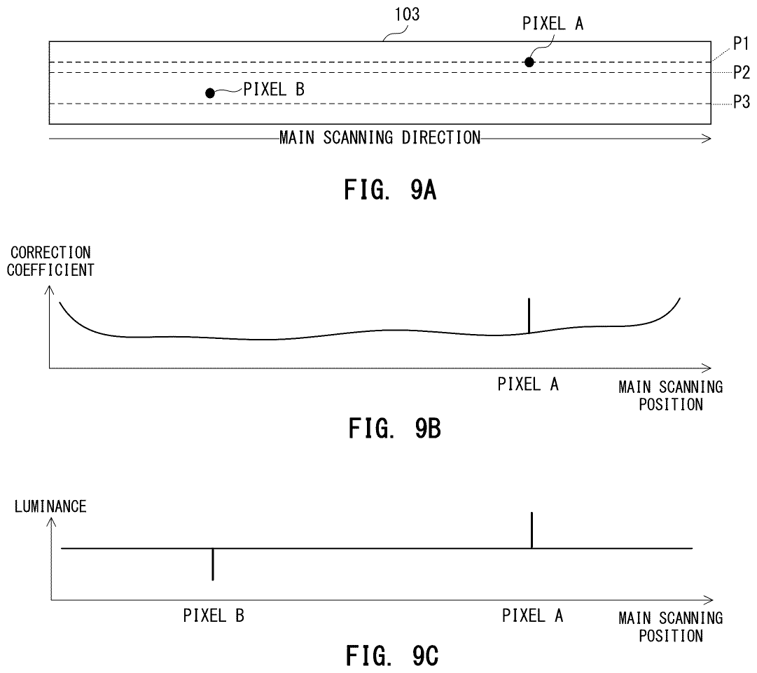

FIG. 8 is a flow chart for illustrating abnormal pixel detection processing. FIG. 9A to FIG. 9C are explanatory views of the abnormal pixel detection. Description is given of a case in which, as illustrated in FIG. 9A, foreign matters (dust) adhere to positions of a pixel A and a pixel B in the main scanning direction of the front-surface white reference member 103. The pixel A has a position in the sub-scanning direction of the position P1. The pixel B has a position in the sub-scanning direction between the position P2 and the position P3.

The CPU 301 of the reader 40 moves the front surface reading unit 104 to the position P1 (home position) of FIG. 5A (Step S110). The position P1 is hereinafter also referred to as “HP position.” In a case where the front surface reading unit 104 is already at the HP position, the processing step of Step S110 is omitted. Whether or not the front surface reading unit 104 is at the HP position is determined by the detection result obtained by the optical system HP sensor 226.

The CPU 301 causes the front surface reading unit 104 to read the front-surface white reference member 103 at the HP position under a state in which the LED 105 is turned off, to thereby perform black level adjustment (Step S111). In the black level adjustment, luminance unevenness correction in the main scanning direction is performed under an LED off state (dark time), and the output variations at the dark time of the front surface reading unit 104 are mainly corrected. Through correction of the output variations at the dark time, the luminance unevenness in the main scanning direction at the time of black original reading is corrected, and the input dynamic range can be ensured at the same time.

The CPU 301 causes the front surface reading unit 104 to read the front-surface white reference member 103 under a reading setting set so that the maximum value of the reading result (luminance value) becomes darker than that at the time of normal image reading. Accordingly, the CPU 301 turns on the LED 105 at the HP position (Step S112), and causes the front surface reading unit 104 to read the front-surface white reference member 103 (Step S113). The CPU 301 acquires reference shading correction data for abnormal pixel detection based on the reading result (reading data). The reference shading correction data is obtained from an addition average result of values of pieces of reading data of the respective pixels in the main scanning direction. FIG. 9B is an exemplary graph of the reference shading correction data. At the position of the pixel A, the value of the reading data becomes darker (lower) than those of the surrounding pixels due to the influence of the dust, and hence the correction coefficient for correcting the pixel so that the pixel becomes white is a value higher than the values of the surroundings.

The CPU 301 drives the optical system motor 225 to move the front surface reading unit 104 from the HP position to the position P3 (Step S114). In this manner, the front surface reading unit 104 is moved from the state of FIG. 5A to the state of FIG. 5B. The CPU 301 reads the front-surface white reference member 103 while moving the front surface reading unit 104 based on the reference shading correction data (Step S115). In this case, the front surface reading unit 104 reads the front-surface white reference member 103 in a region from the position P2 to the position P3 a plurality of times while moving from the position P1 to the position P3 of FIG. 5B.

The CPU 301 stands by until the front surface reading unit 104 is moved to the position P3 and the reading of the front-surface white reference member 103 is ended (Step S116: N). After the reading of the front-surface white reference member 103 is ended (Step S116: Y), the CPU 301 performs abnormal pixel detection for the front-surface white reference member 103 (Step S117). The CPU 301 detects the abnormal pixel from an addition average result of values of pieces of reading data of the respective pixels in the main scanning direction.

FIG. 9C shows an addition average result of the reading results (pieces of reading data) obtained by the processing step of Step S115. In this case, a luminance value is obtained as the reading result. With the shading correction using the reference shading correction data, the pixels in the main scanning direction entirely have a uniform luminance. However, at the position of the pixel A, the front-surface white reference member 103 is read under a state in which the shading correction coefficient is high due to the influence of dust, and hence the luminance value is high. At the position of the pixel B, the luminance value is low because the dust is read.

The CPU 301 compares the reading data and a predetermined dust detection threshold value so as to detect a pixel having reading data equal to or lower than the dust detection threshold value as the abnormal pixel. The dust detection threshold value for determining the abnormal pixel is set based on the average luminance value (average value of pieces of reading data) of the pixels of one line in the main scanning direction. The reading is performed a plurality of times, and hence a value obtained by averaging average luminance values of the respective lines for a plurality of lines may be set as the dust detection threshold value. The CPU 301 stores the position of the detected abnormal pixel into a memory such as the RAM 303 (Step S118). In this manner, only a pixel at which dust is present in a region from the position P2 to the position P3 can be detected. The CPU 301 reversely rotates the optical system motor 225 to move the front surface reading unit 104 from the position P3 to the HP position (P1) as illustrated in FIG. 5C, and ends the abnormal pixel detection (Step S119).

### Abnormal Pixel Correction

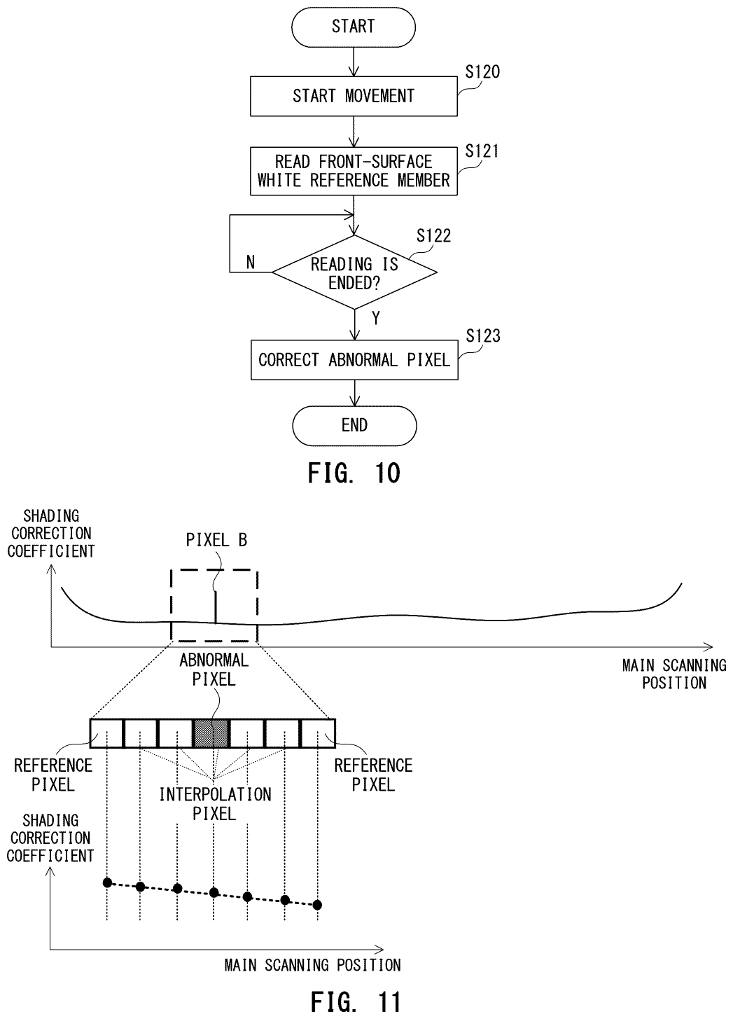

FIG. 10 is a flow chart for illustrating processing of correcting the detected abnormal pixel. The front surface reading unit 104 that has performed detection of the abnormal pixel by the processing of FIG. 8 stands by at the HP position (P1) under a state in which the LED 105 is turned on.

The CPU 301 drives the optical system motor 225 to start movement of the front surface reading unit 104 from the HP position to the position P3 as illustrated in FIG. 5D (Step S120). The CPU 301 reads the front-surface white reference member 103 a plurality of times in the region from the position P2 to the position P3 while moving the front surface reading unit 104 under the setting at the time of the normal image reading (Step S121).

The CPU 301 stands by until the front surface reading unit 104 is moved to the position P3 and the reading of the front-surface white reference member 103 is ended (Step S122: N). After the reading is ended (Step S122: Y), the CPU 301 performs abnormal pixel correction of the reading result (reading data) of the front-surface white reference member 103 (Step S123).

FIG. 11 is an explanatory view of a result of the abnormal pixel correction. The shading correction data obtained from the reading data includes an abnormal value caused by the foreign matter at the pixel B. In a case where the abnormal value of the abnormal pixel (pixel B) is to be corrected, linear interpolation is performed through use of shading correction data of a pixel (reference pixel) having a normal value adjacent to the abnormal pixel. In FIG. 11, interpolation of the abnormal pixel B is performed through use of an interpolation pixel included in the reference pixel. In this manner, shading correction data suppressed in influence of the abnormal pixel is generated.

### Reading of Original

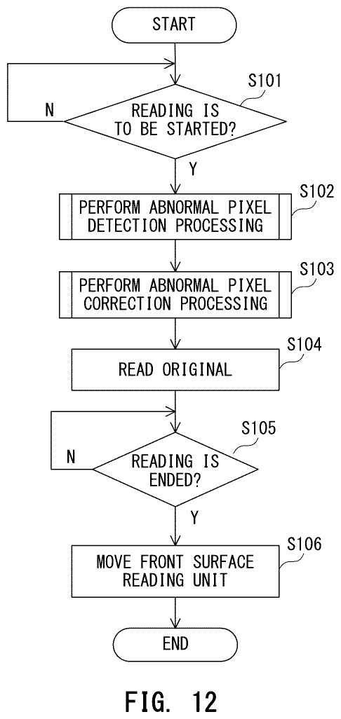

FIG. 12 is a flow chart for illustrating processing of reading the original by the automatic original reading apparatus 10 having the configuration as described above. FIG. 12 shows processing of reading one surface (front surface) of the original in the flow reading mode using the ADF 20.

The CPU 301 of the reader 40 stands by until a reading start instruction is acquired from the CPU 311 of the controller 310 (Step S101: N). As described above, the CPU 311 of the controller 310 acquires the instruction to start the image reading job from the operation unit 90 or an external apparatus such as a personal computer to transmit the reading start instruction to the CPU 301 of the reader 40. In a case where the CPU 311 acquires the instruction to start the image reading job, the CPU 311 transmits the reading start instruction to the CPU 301 of the reader 40. In a case where the CPU 301 acquires the reading start instruction from the CPU 311 (Step S101: Y), the CPU 301 performs abnormal pixel detection processing for the front-surface white reference member 103 illustrated in FIG. 8 (Step S102).

After the execution of the abnormal pixel detection processing, the CPU 301 performs the abnormal pixel correction processing for the front-surface white reference member 103 illustrated in FIG. 10 (Step S103). After the abnormal pixel correction processing is ended, the CPU 301 drives the optical system motor 225 to move the front surface reading unit 104 to the reading start position Ps illustrated in FIG. 5E, and starts the reading of the original (Step S104). After the movement of the front surface reading unit 104 to the reading start position Ps is finished, the CPU 301 causes the ADF 20 to convey the original to the reading position of the front surface reading unit 104, and performs reading of the original. The front surface reading unit 104 repeatedly reads the conveyed original one line by one line.

The CPU 301 stands by until the reading of all originals is ended (Step S105: N). The CPU 301 determines that the reading of all originals is ended when, for example, based on the detection results of the first original presence/absence detection sensor 204 and the second original presence/absence detection sensor 205, the absence of the original placed on the original tray 121 is detected. After the reading of all originals is ended (Step S105: Y), the CPU 301 drives the optical system motor 225 to move the front surface reading unit 104 to the HP position (P1), and ends the processing (Step S106).

In the above-mentioned example, description is given of a case in which the flow reading is performed, but in a case where the fixed reading is performed, the original is placed on the platen 101. After the processing steps of from Step S101 to Step S103 are ended, the CPU 301 moves the front surface reading unit 104 to the reading start position Ps. After that, the CPU 301 repeatedly reads the original placed on the platen 101 one line by one line while moving the front surface reading unit 104 in the sub-scanning direction.

As described above, at the time of detecting the abnormal pixel of the front-surface white reference member 103 and the time of correcting the abnormal pixel of the front-surface white reference member 103, the automatic original reading apparatus 10 (reader 40) of the first embodiment reads the front-surface white reference member 103 while moving the front surface reading unit 104. In this manner, even when an inexpensive white reference member is used, the automatic original reading apparatus 10 (reader 40) can detect the abnormal pixel of the white reference member without being affected by the unevenness of the surface of the white reference member. Thus, accurate shading correction can be performed.

### Second Embodiment

A configuration of the automatic original reading apparatus 10 and a configuration of the control system in a second embodiment of the present disclosure are similar to those in the first embodiment, and hence description of the configuration of the automatic original reading apparatus 10 and the configuration of the control system is omitted. The second embodiment is similar to the first embodiment in processing other than the abnormal pixel detection for the front-surface white reference member 103. Description of the similar processing is omitted.

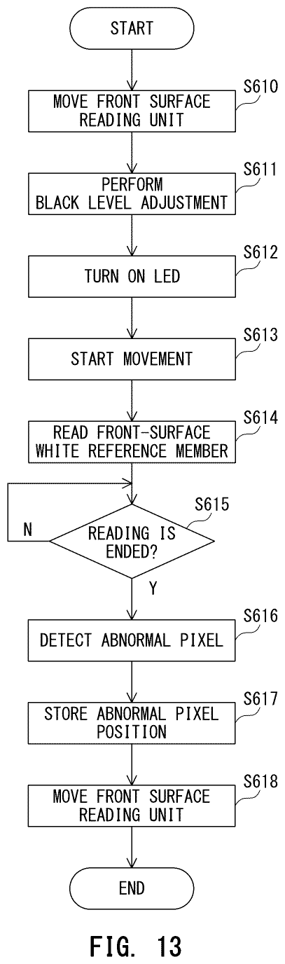

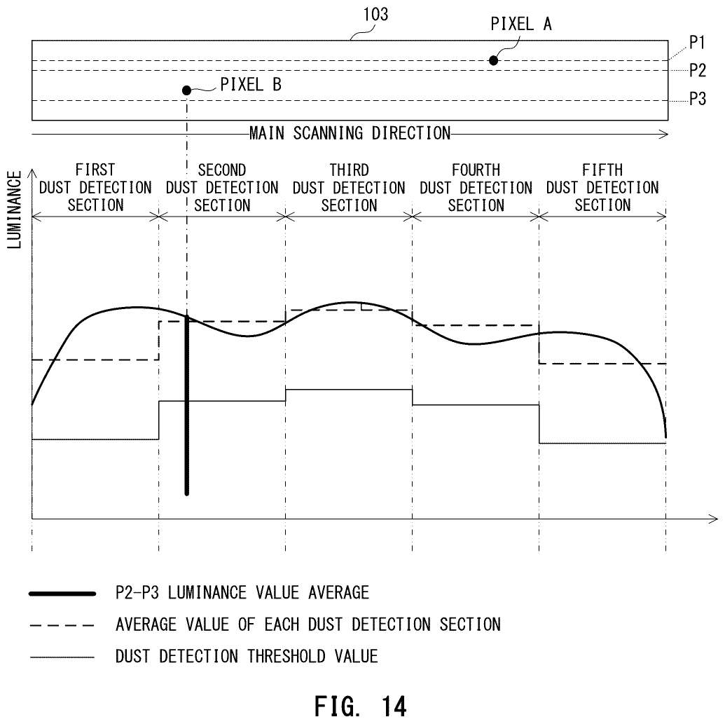

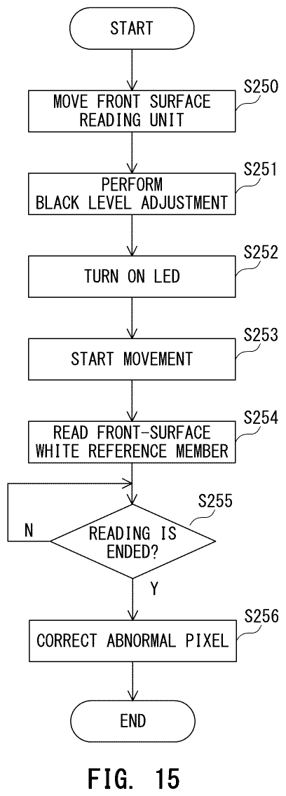

The abnormal pixel detection for the front-surface white reference member 103 in the second embodiment is performed based on the reading result (reading data) of the front-surface white reference member 103 obtained by the front surface reading unit 104. In this case, description is given of a case in which foreign matters (dust) adhere to positions (pixel A and pixel B) exemplified in FIG. 9A. FIG. 13 is a flow chart for illustrating abnormal pixel detection processing. FIG. 14 is an explanatory view of abnormal pixel detection.

Similarly to the processing steps of Step S110 and Step S111 of the abnormal pixel detection processing in the first embodiment of FIG. 8, the CPU 301 moves the front surface reading unit 104 to the HP position to perform black level adjustment (Step S610 and Step S611). The CPU 301 turns on the LED 105 (Step S612), and drives the optical system motor 225 to start movement of the front surface reading unit 104 from the HP position to the position P3 as illustrated in FIG. 5B (Step S613).

The CPU 301 successively reads the front-surface white reference member 103 from the position P2 to the position P3 while moving the front surface reading unit 104 (Step S614). The CPU 301 stands by until the reading from the position P2 to the position P3 is ended (Step S615: N). After the reading is ended (Step S615: Y), the CPU 301 performs abnormal pixel detection for the front-surface white reference member 103 (Step S616).

The luminance values of the reading results (pieces of reading data) in the region from the position P2 to the position P3 of the front-surface white reference member 103 entirely have unevenness as exemplified in FIG. 14 due to the unevenness of the surface. At the pixel B, the luminance value becomes extremely lower than those of other pixels. The dust detection threshold value for determining the abnormal pixel is set based on an average luminance value (average value of pieces of reading data) for each predetermined width in the main scanning direction. In FIG. 14, one line in the main scanning direction is divided into a plurality of sections of first to fifth dust detection sections, and the dust detection threshold value is set for each dust detection section.

The CPU 301 detects a position of a pixel (in this case, the pixel B) having a luminance value which is a reading result equal to or lower than the dust detection threshold value as the abnormal pixel, and stores the position of the detected abnormal pixel into a memory such as the RAM 303 (Step S617). In this manner, even when the reading result (reading data) has unevenness, the position of the abnormal pixel can be accurately detected. The CPU 301 reversely rotates the optical system motor 225 to move the front surface reading unit 104 from the position P3 to the HP position (P1) as illustrated in FIG. 5C, and ends the abnormal pixel detection (Step S618).

Also in the second embodiment, similarly to the first embodiment, even when an inexpensive white reference member is used, it is possible to detect the abnormal pixel of the white reference member without being affected by the unevenness of the surface of the white reference member. Thus, accurate shading correction can be performed. Further, even when the reading data has unevenness entirely in the main scanning direction, the threshold value for detecting the abnormal pixel is set for each section obtained by dividing the main scanning direction into a plurality of sections, and hence the abnormal pixel can be accurately detected.

### Third Embodiment

A configuration of the automatic original reading apparatus 10 and a configuration of the control system in a third embodiment of the present disclosure are similar to those in the first embodiment, and hence description of the configuration of the automatic original reading apparatus 10 and the configuration of the control system is omitted. In the third embodiment, the abnormal pixel detection processing is similar to that in the first embodiment, and hence description thereof is omitted. Also in the third embodiment, the abnormal pixel detection processing in the second embodiment is effective. The third embodiment is different from the first embodiment and the second embodiment in the abnormal pixel correction processing and the original reading processing.

FIG. 15 is a flow chart for illustrating the abnormal pixel correction processing in the third embodiment.

The CPU 301 drives the optical system motor 225 to move the front surface reading unit 104 to the HP position (Step S250). In a case where the front surface reading unit 104 is already at the HP position, the processing step of Step S250 is omitted. The CPU 301 causes the front surface reading unit 104 to read the front-surface white reference member 103 at the HP position under a state in which the LED 105 is turned off, to thereby perform black level adjustment (Step S251). This processing step is similar to the processing step of Step S111 of FIG. 8. After that, the CPU 301 turns on the LED 105 (Step S252). The CPU 301 corrects the abnormal pixel through processing steps similar to the processing steps of Step S120 to Step S123 of FIG. 10 in the first embodiment (Step S253 to Step S256).

The shading correction data generated based on the reading result (reading data) of the front-surface white reference member 103 obtained in the processing step of Step S254 is similar to the shading correction data obtained in the processing step of Step S121 of FIG. 10 in the first embodiment. In this case, the shading correction data is as illustrated in FIG. 11. The abnormal pixel correction is performed by, similarly to the first embodiment, as illustrated in FIG. 11, linear interpolation of the shading correction data of the abnormal pixel through use of the shading correction data of a normal pixel adjacent to the abnormal pixel. In this manner, the shading correction data suppressed in influence of the abnormal pixel can be obtained.

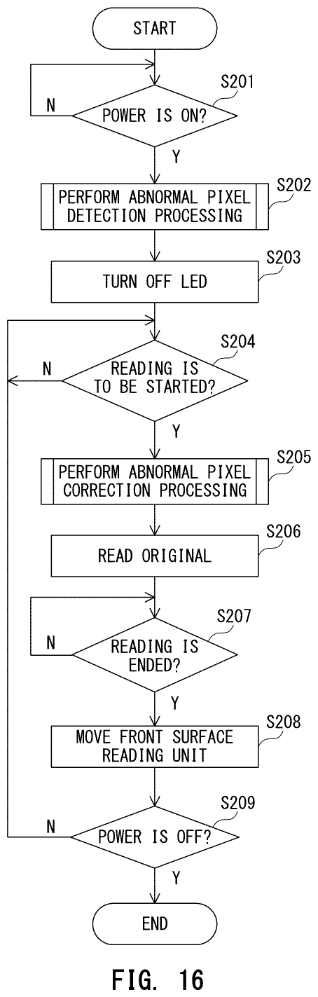

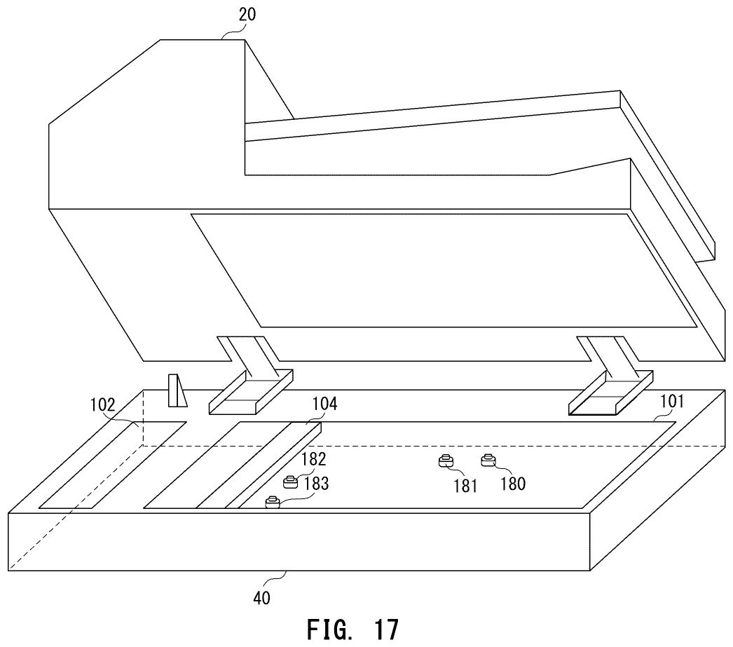

FIG. 16 is a flow chart for illustrating processing of reading the original in the third embodiment. FIG. 16 shows processing of reading one surface (front surface) of the original in the flow reading mode using the ADF 20.

The CPU 301 stands by until the automatic original reading apparatus 10 is powered on (Step S201: N). In a case where the automatic original reading apparatus 10 is powered on (Step S201: Y), the CPU 301 performs the abnormal pixel detection processing for the front-surface white reference member 103 described above, and stores the abnormal pixel position (Step S202). The CPU 301 turns off the LED 105 after the abnormal pixel detection processing (Step S203), and stands by until the reading start instruction described above is acquired (Step S204: N).

After the CPU 301 acquires the reading start instruction from the CPU 311 (Step S204: Y), the CPU 301 performs the abnormal pixel correction processing illustrated in FIG. 15 (Step S205). After the abnormal pixel correction processing is ended, the CPU 301 drives the optical system motor 225 to move the front surface reading unit 104 to the reading start position Ps illustrated in FIG. 5E, and performs reading of the original (Step S206). This processing step is similar to the processing step of Step S104 of FIG. 12.

Similarly to the processing step of Step S105 of FIG. 12, the CPU 301 stands by until the reading of all of the originals is ended (Step S207: N). After the reading of all of the originals is ended (Step S207: Y), the CPU 301 drives the optical system motor 225 to move the front surface reading unit 104 to the HP position (P1) (Step S208). After the front surface reading unit 104 is moved to the HP position (P1), the CPU 301 repeatedly performs the processing steps of from Step S204 to Step S208 until the automatic original reading apparatus 10 is powered off (Step S209: N). In a case where the automatic original reading apparatus 10 is powered off (Step S209: Y), the CPU 301 ends the original reading processing.

In the above-mentioned example, description is given of a case in which the flow reading is performed, but in a case where the fixed reading is performed, the original is placed on the platen 101. After the processing steps of from Step S201 to Step S205 are ended, the CPU 301 moves the front surface reading unit 104 to the reading start position Ps. After that, the CPU 301 repeatedly reads the original placed on the platen 101 one line by one line while moving the front surface reading unit 104 in the sub-scanning direction.

In the processing of FIG. 16, it is determined in the processing step of Step S201 and the processing step of Step S209 whether or not the power of the automatic original reading apparatus 10 is operated, but this determination may be determination as to a power saving state (sleep state). That is, the CPU 301 waits for the recovery from the power saving state in the processing step of Step S201, and determines whether the state has shifted to the power saving state in the processing step of Step S209.

In the third embodiment described above, the front-surface white reference member 103 is read while the front surface reading unit 104 is moved at the time of abnormal pixel detection for the white reference member and the time of the abnormal pixel correction for the white reference member. Accordingly, even when an inexpensive white reference member is used, the abnormal pixel of the white reference member can be detected without being affected by the unevenness of the surface of the white reference member. Thus, accurate shading correction can be performed. Further, the abnormal pixel detection for the white reference member is performed in advance at the time of start-up of the automatic original reading apparatus 10 (at the time of power-on or at the time of recovery from the power saving state) so that a time period required from reading start to end can be shortened.

### Fourth Embodiment

A configuration of the automatic original reading apparatus 10 and a configuration of the control system in a fourth embodiment of the present disclosure are similar to those in the first embodiment, and hence description of the configuration of the automatic original reading apparatus 10 and the configuration of the control system is omitted. In the fourth embodiment, the abnormal pixel detection processing is similar to that in the first embodiment or the second embodiment, and hence description thereof is omitted. In the fourth embodiment, the abnormal pixel correction processing is similar to that in the third embodiment, and hence description thereof is omitted.

In the fourth embodiment, placement of the original onto the original tray 121 of the ADF 20 or the platen 101 is detected. In a case where the first original presence/absence detection sensor 204 detects the original, it can be determined that the original has been placed onto the original tray 121 of the ADF 20. In a case where the first original presence/absence detection sensor 204 detects no original, it can be determined that the original has been removed from the top of the original tray 121.

The placement of the original onto the platen 101 can be detected by providing a sensor below the platen 101. FIG. 17 is an explanatory view of sensors provided below the platen 101. In FIG. 17, a plurality of original detection sensors 180, 181, 182, and 183 for detecting presence or absence of the original on the platen 101 are provided below the platen 101. In a case where at least one of the original detection sensors 180, 181, 182, and 183 detects the original, it can be determined that the original is placed on the platen 101. In a case where none of the original detection sensors 180, 181, 182, and 183 detects the original, it can be determined that the original has been removed from the top of the platen 101. The original detection sensors 180, 181, 182, and 183 are, for example, optical sensors, and can detect the presence or absence of the original based on whether or not light applied toward the platen 101 is reflected.

In a case where the original placement onto the original tray 121 of the ADF 20 and the original placement onto the platen 101 are both detected, it is determined that the original has been placed on the original tray 121. Further, in a case where no original is detected on any of the original tray 121 of the ADF 20 and the platen 101, it is determined that the original is placed on the platen 101.

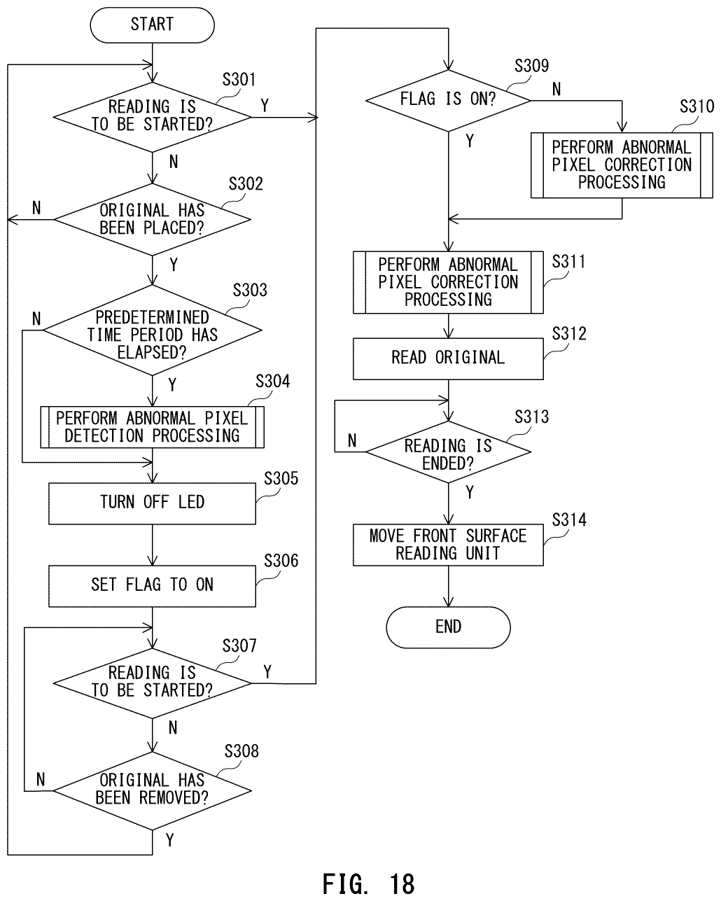

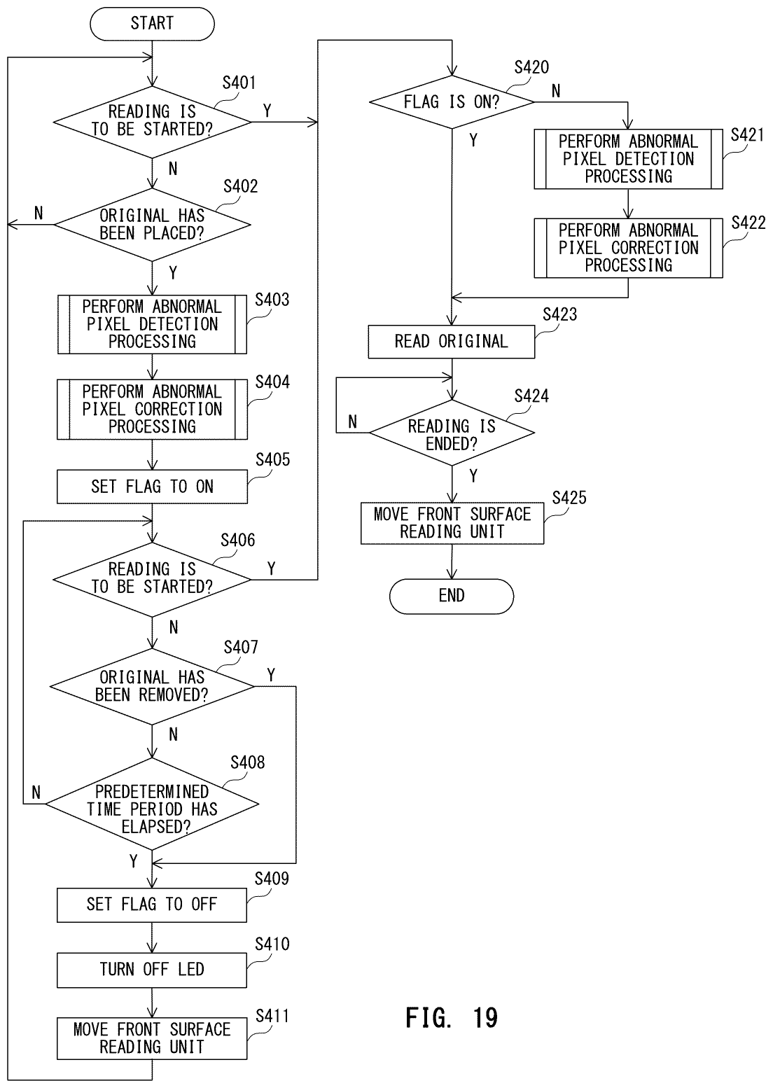

FIG. 18 is a flow chart for illustrating processing of reading the original in the fourth embodiment. FIG. 18 shows processing of reading one surface (front surface) of the original.

The CPU 301 determines whether or not the reading start instruction has been acquired similarly to Step S101 of FIG. 12 (Step S301). In a case where no reading start instruction is acquired (Step S301: N), the CPU 301 determines whether the original placement onto the original tray 121 of the ADF 20 or the original placement onto the platen 101 has been performed (Step S302). In a case where no original is placed on any of the original tray 121 of the ADF 20 and the platen 101 (Step S302: N), the process returns to the processing step of S301, and the CPU 301 determines whether the reading start instruction has been acquired. In a case where it is determined that the original has been placed (Step S302: Y), the CPU 301 determines whether or not a predetermined time period has elapsed from the previous abnormal pixel detection processing (Step S303). Accordingly, the CPU 301 includes a built-in timer to count the elapsed time period from the previous abnormal pixel detection processing. In a case where the predetermined time period has elapsed (Step S303: Y), the CPU 301 performs the abnormal pixel detection processing described above (Step S304). The predetermined time period in Step S303 is, for example, 6 hours, but may be 0 hours. In a case where the predetermined time period is 0 hours, the abnormal pixel detection processing is performed every time the original is placed.

In a case where the predetermined time period has not elapsed (Step S303: N), or after the abnormal pixel detection processing is performed, the CPU 301 turns off the LED 105 of the front surface reading unit 104 (Step S305). The CPU 301 sets a flag (abnormal pixel detection execution flag) indicating that the abnormal pixel detection has been performed to ON (Step S306). The abnormal pixel detection execution flag is held in the RAM 303.

After that, the CPU 301 determines whether or not the reading start instruction has been acquired similarly to the processing step of Step S301 (Step S307). In a case where no reading start instruction is acquired (Step S307: N), the CPU 301 determines whether or not the original has been removed (Step S308). In a case where the original has been removed (Step S308: Y), the process returns to the processing step of Step S301, and the CPU 301 determines whether or not the reading start instruction has been acquired. In a case where the original has not been removed (Step S308: N), the process returns to the processing step of Step S307, and the CPU 301 determines whether or not the reading start instruction has been acquired.

In a case where the reading start instruction is acquired from the CPU 311 in the processing step of Step S301 or the processing step of Step S307 (Step S301: Y, or Step S307: Y), the CPU 301 determines whether or not the abnormal pixel detection execution flag stored in the RAM 303 is ON (Step S309). In a case where the abnormal pixel detection execution flag is not ON (Step S309: N), the CPU 301 performs the abnormal pixel detection processing because the abnormal pixel detection processing for the front-surface white reference member 103 is not performed (Step S310). In a case where the abnormal pixel detection execution flag is ON (Step S309: Y), or after the abnormal pixel detection processing is executed, the CPU 301 performs the abnormal pixel correction processing described above (Step S311).

The abnormal pixel detection processing and the abnormal pixel correction processing for the front-surface white reference member 103 are thus ended. After that, the CPU 301 drives the optical system motor 225 to move the front surface reading unit 104 to the reading start position Ps illustrated in FIG. 5E, and performs reading of the original (Step S312). In a case where the original is placed on the original tray 121 of the ADF, the flow reading in the flow reading mode is performed. In a case where the original is placed on the platen 101, the fixed reading in the fixed reading mode is performed.

Similarly to the processing step of Step S105, the CPU 301 stands by until the reading of all of the originals is ended (Step S313: N). After the reading of all of the originals is ended (Step S313: Y), the CPU 301 drives the optical system motor 225 to move the front surface reading unit 104 to the HP position (P1) (Step S314). The processing of reading the original is thus ended.

In the fourth embodiment described above, the front-surface white reference member 103 is read while the front surface reading unit 104 is moved at the time of abnormal pixel detection for the white reference member and the time of the abnormal pixel correction for the white reference member. Accordingly, even when an inexpensive white reference member is used, the abnormal pixel of the white reference member can be detected without being affected by the unevenness of the surface of the white reference member. Thus, accurate shading correction can be performed. Further, the abnormal pixel detection for the white reference member is performed in advance at a timing at which the original is placed on the original tray 121 or the platen 101, and hence the time period required from the original reading start to end can be shortened.

### Fifth Embodiment

A configuration of the automatic original reading apparatus 10 and a configuration of the control system in a fifth embodiment of the present disclosure are similar to those in the first embodiment, and hence description of the configuration of the automatic original reading apparatus 10 and the configuration of the control system is omitted. In the fifth embodiment, the abnormal pixel detection processing is similar to that in the first embodiment or the second embodiment, and hence description thereof is omitted. In the fifth embodiment, the abnormal pixel correction processing is similar to that in the first embodiment or the third embodiment, and hence description thereof is omitted. In the fifth embodiment, similarly to the fourth embodiment, the original placement onto the original tray 121 or the original placement onto the platen 101 is detected.

FIG. 19 is a flow chart for illustrating processing of reading the original in the fifth embodiment. FIG. 19 shows processing of reading one surface (front surface) of the original.

The CPU 301 waits for the reading start instruction and determines whether the original has been placed similarly to the processing steps of Step S301 and Step S302 of FIG. 18 in the fourth embodiment (Step S401 and Step S402). In a case where no reading start instruction is acquired and the original has been placed (Step S401: N, and Step S402: Y), the CPU 301 performs the abnormal pixel detection processing described above (Step S403). After the abnormal pixel detection processing is ended, the CPU 301 performs the abnormal pixel correction processing described above (Step S404). The CPU 301 sets a flag (abnormal pixel detection execution flag) indicating that the abnormal pixel detection has been performed to ON (Step S405). The abnormal pixel detection execution flag is held in the RAM 303.

After that, the CPU 301 determines whether or not the reading start instruction has been acquired similarly to the processing step of Step S401 (Step S406). In a case where no reading start instruction is acquired (Step S406: N), the CPU 301 determines whether or not the original has been removed (Step S407). In a case where the original has not been removed (Step S407: N), the CPU 301 determines whether or not a predetermined time period has elapsed from when the abnormal pixel detection execution flag is set to ON (Step S408). The predetermined time period is, for example, 15 seconds. In a case where the predetermined time period has not elapsed (Step S408: N), the process returns to the processing step of Step S406, and the CPU 301 determines whether or not the reading start instruction has been acquired.

In a case where the predetermined time period has elapsed (Step S408: Y), or the original has been removed (Step S407: Y), the CPU 301 sets the abnormal pixel detection execution flag to OFF (Step S409). That is, the CPU 301 sets, by the processing steps of from Step S406 to Step S408, the abnormal pixel detection execution flag to OFF in a case where no reading start instruction is acquired even after the elapse of the predetermined time period from when the abnormal pixel detection execution flag is set to ON. Further, the CPU 301 sets the abnormal pixel detection execution flag to OFF in a case where the original is removed even before the elapse of the predetermined time period from when the abnormal pixel detection execution flag is set to ON.

The CPU 301 which has set the abnormal pixel detection execution flag to OFF turns off the LED 105 (Step S410), and moves the front surface reading unit 104 to the HP position (P1) (Step S411). After that, the process returns to the processing step of Step S401, and the CPU 301 waits for the reading start instruction.

In a case where the reading start instruction is acquired from the CPU 311 in the processing step of Step S401 or the processing step of Step S406 (Step S401: Y, or Step S406: Y), the CPU 301 determines whether or not the abnormal pixel detection execution flag stored in the RAM 303 is ON (Step S420). In a case where the abnormal pixel detection execution flag is not ON (Step S420: N), the CPU 301 determines that the abnormal pixel detection processing and the abnormal pixel correction processing for the front-surface white reference member 103 are not performed, and performs the abnormal pixel detection processing and the abnormal pixel correction processing again (Step S421 and Step S422).

In a case where the abnormal pixel detection execution flag is ON (Step S420: Y), or after the abnormal pixel detection processing and the abnormal pixel correction processing are executed, the CPU 301 drives the optical system motor 225 to move the front surface reading unit 104 to the reading start position Ps, and performs reading of the original (Step S423). In a case where the original is placed on the original tray 121 of the ADF, the flow reading in the flow reading mode is performed. In a case where the original is placed on the platen 101, the fixed reading in the fixed reading mode is performed.

Similarly to the processing step of Step S105, the CPU 301 stands by until the reading of all of the originals is ended (Step S424: N). After the reading of all of the originals is ended (Step S424: Y), the CPU 301 drives the optical system motor 225 to move the front surface reading unit 104 to the HP position (P1) (Step S425). The processing of reading the original is thus ended.

In the fifth embodiment described above, the front-surface white reference member 103 is read while the front surface reading unit 104 is moved at the time of abnormal pixel detection for the white reference member and the time of the abnormal pixel correction for the white reference member. Accordingly, even when an inexpensive white reference member is used, the abnormal pixel of the white reference member can be detected without being affected by the unevenness of the surface of the white reference member. Thus, accurate shading correction can be performed. Further, the abnormal pixel detection and the abnormal pixel correction for the white reference member are performed in advance at a timing at which the original is placed on the original tray 121 or the platen 101, and hence the time period required from the original reading start to end can be shortened.

### Sixth Embodiment

A configuration of the automatic original reading apparatus 10 and a configuration of the control system in a sixth embodiment of the present disclosure are similar to those in the first embodiment, and hence description of the configuration of the automatic original reading apparatus 10 and the configuration of the control system is omitted. In the sixth embodiment, the abnormal pixel detection processing is similar to that in the first embodiment or the second embodiment, and hence description thereof is omitted. In the sixth embodiment, similarly to the fourth embodiment, the original placement onto the original tray 121 or the original placement onto the platen 101 is detected.

The abnormal pixel correction processing in the sixth embodiment is described. The abnormal pixel correction processing in the sixth embodiment is executed by any of the two types of processing depending on an execution state of the abnormal pixel detection processing. In a case where the abnormal pixel correction processing is performed subsequently to the abnormal pixel detection processing, the CPU 301 performs the processing of the flow chart illustrated in FIG. 10 in the first embodiment. In a case where the abnormal pixel correction processing is performed alone, the CPU 301 performs the processing of the flow chart illustrated in FIG. 15 in the third embodiment.

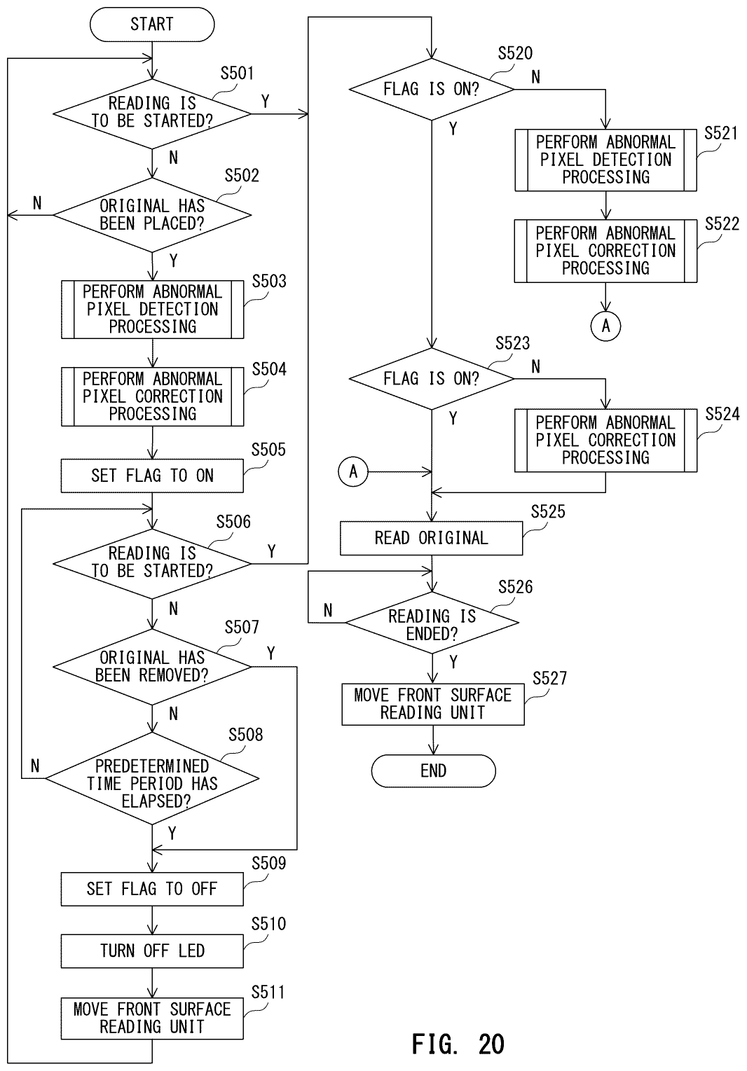

FIG. 20 is a flow chart for illustrating processing of reading the original in the sixth embodiment. FIG. 20 shows processing of reading one surface (front surface) of the original.

The CPU 301 waits for the reading start instruction and determines whether the original has been placed similarly to the processing steps of Step S301 and Step S302 of FIG. 18 in the fourth embodiment (Step S501 and Step S502). In a case where no reading start instruction is acquired and the original has been placed (Step S501: N, and Step S502: Y), the CPU 301 performs the abnormal pixel detection processing described above (Step S503). After the abnormal pixel detection processing is ended, the CPU 301 performs the abnormal pixel correction processing illustrated in FIG. 10 (Step S504). The CPU 301 sets a flag indicating that the abnormal pixel detection has been performed (abnormal pixel detection execution flag) and a flag indicating that the abnormal pixel correction has been performed (abnormal pixel correction execution flag) to ON (Step S505). The abnormal pixel detection execution flag and the abnormal pixel correction execution flag are held in the RAM 303.

After that, the CPU 301 determines whether or not the reading start instruction has been acquired similarly to the processing step of Step S501 (Step S506). In a case where no reading start instruction is acquired (Step S506: N), the CPU 301 determines whether or not the original has been removed (Step S507). In a case where the original has not been removed (Step S507: N), the CPU 301 determines whether or not a predetermined time period has elapsed from when the abnormal pixel detection execution flag and the abnormal pixel correction execution flag are set to ON (Step S508). The predetermined time period is, for example, 15 seconds. In a case where the predetermined time period has not elapsed (Step S508: N), the process returns to the processing step of Step S506, and the CPU 301 determines whether or not the reading start instruction has been acquired.

In a case where the predetermined time period has elapsed (Step S508: Y), or the original has been removed (Step S507: Y), the CPU 301 sets the abnormal pixel correction execution flag to OFF (Step S509). That is, the CPU 301 sets, by the processing steps of from Step S506 to Step S508, the abnormal pixel correction execution flag to OFF in a case where no reading start instruction is acquired even after the elapse of the predetermined time period from when the abnormal pixel correction execution flag is set to ON. Further, the CPU 301 sets the abnormal pixel correction execution flag to OFF in a case where the original is removed even before the elapse of the predetermined time period from when the abnormal pixel correction execution flag is set to ON.

The CPU 301 which has set the abnormal pixel correction execution flag to OFF turns off the LED 105 (Step S510), and moves the front surface reading unit 104 to the HP position (P1) (Step S511). After that, the process returns to the processing step of Step S501, and the CPU 301 waits for the reading start instruction.

In a case where the reading start instruction is acquired from the CPU 311 in the processing step of Step S501 or the processing step of Step S506 (Step S501: Y, or Step S506: Y), the CPU 301 determines whether or not the abnormal pixel detection execution flag stored in the RAM 303 is ON (Step S520). In a case where the abnormal pixel detection execution flag is not ON (Step S520: N), the CPU 301 determines that the abnormal pixel detection processing and the abnormal pixel correction processing for the front-surface white reference member 103 are not performed, and performs the abnormal pixel detection processing and the abnormal pixel correction processing again (Step S521 and Step S522). In this case, the abnormal pixel detection processing and the abnormal pixel correction processing are successively performed, and hence the CPU 301 performs the abnormal pixel correction processing illustrated in FIG. 10.

In a case where the abnormal pixel detection execution flag is ON (Step S520: Y), the CPU 301 determines whether or not the abnormal pixel correction execution flag stored in the RAM 303 is ON (Step S523). In a case where the abnormal pixel correction execution flag is not ON (Step S523: N), the CPU 301 determines that the abnormal pixel correction processing for the front-surface white reference member 103 is not performed, and performs the abnormal pixel correction processing again (Step S524). In this case, the abnormal pixel correction processing is performed alone, and hence the CPU 301 performs the abnormal pixel correction processing illustrated in FIG. 15.

In a case where the abnormal pixel correction execution flag is ON (Step S523: Y), after the abnormal pixel correction processing of Step S522 is executed, or after the abnormal pixel correction processing of Step S524 is executed, the execution of the abnormal pixel detection processing and the abnormal pixel correction processing is finished. In this case, the CPU 301 drives the optical system motor 225 to move the front surface reading unit 104 to the reading start position Ps, and performs reading of the original (Step S525). In a case where the original is placed on the original tray 121 of the ADF, the flow reading in the flow reading mode is performed. In a case where the original is placed on the platen 101, the fixed reading in the fixed reading mode is performed.

Similarly to the processing step of Step S105, the CPU 301 stands by until the reading of all of the originals is ended (Step S526: N). After the reading of all of the originals is ended (Step S526: Y), the CPU 301 drives the optical system motor 225 to move the front surface reading unit 104 to the HP position (P1) (Step S527). The processing of reading the original is thus ended.

In the sixth embodiment described above, the front-surface white reference member 103 is read while the front surface reading unit 104 is moved at the time of abnormal pixel detection for the white reference member and the time of the abnormal pixel correction for the white reference member. Accordingly, even when an inexpensive white reference member is used, the abnormal pixel of the white reference member can be detected without being affected by the unevenness of the surface of the white reference member. Thus, accurate shading correction can be performed. Further, the abnormal pixel detection and the abnormal pixel correction for the white reference member are performed in advance at a timing at which the original is placed on the original tray 121 or the platen 101, and hence the time period required from the reading start to end can be shortened.

In the first to sixth embodiments, the CPU 301 causes the image processor 306 to perform shading correction of the reading data obtained by reading the original, based on the shading correction data. In this manner, even when a foreign matter adheres to the front-surface white reference member 103, the shading correction can be accurately performed, and the original can be read with high accuracy.

### Image Forming System

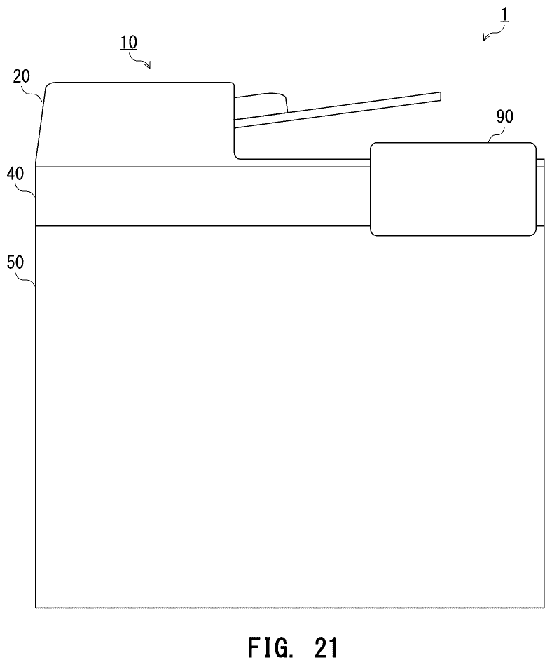

FIG. 21 is a configuration view of an image forming system including the automatic original reading apparatus 10 described in any one of the first to sixth embodiments, an image forming apparatus, and the operation unit 90. In an image forming system 1, the reader 40 is provided on an image forming apparatus 50, and the ADF 20 is provided on the reader 40. The operation unit 90 is provided on the front side of the automatic original reading apparatus 10 and the image forming apparatus 50. With the image forming system 1 described above, a high-functional image forming apparatus such as a copying machine, a multifunction machine, or an MFP is achieved.

In a case where the copying of the original is performed, the image data generated by reading the original by the reader 40 is transmitted to the image forming apparatus 50. This image data has been subjected to shading correction through use of the shading correction data. The image forming apparatus 50 forms an image onto a sheet based on the image data acquired from the reader 40. The image forming apparatus 50 performs image formation onto the sheet with a system normally used for image formation, such as an electrographic system or an inkjet system. The time period required from reading start to end of the reader 40 is shortened, and hence the first copy output time is reduced.

The image forming apparatus 50 may be connected to an external apparatus via a predetermined network. In this case, the image forming apparatus 50 may transmit the image data acquired from the reader 40 to the external apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-020324, filed Feb. 14, 2024, which is hereby incorporated by reference herein in its entirety.

What is claimed is:

1. An image reading apparatus comprising:
a reference member;
a reader configured to read one of an original or the reference member;
a mover configured to move the reader to a first region in which the original is read and a second region in which the reference member is read in a conveying direction of the original; and
at least one processor configured to perform shading correction,
wherein the at least one processor is configured to:
control the reader to move from outside of the second region to inside of the second region in the conveying direction to perform a first reading operation of reading the reference member within the second region;
control the reader to move, after the first reading operation is performed, from the outside of the second region to the inside of the second region again and cause the reader to perform a second reading operation of reading the reference member within the second region; and
perform the shading correction using a first reading result read in the first reading operation and a second reading result read in the second reading operation.

2. The image reading apparatus according to claim 1, wherein the at least one processor is configured to:
detect an abnormal pixel in which the first reading result is an abnormal value based on a predetermined threshold value and the first reading result obtained by causing the reader to read different positions within the second region of the reference member a plurality of times by the first reading operation;
generate shading correction data by correcting the abnormal pixel based on the second reading result obtained by causing the reader to read different positions within the second region of the reference member a plurality of times by the second reading operation; and
perform the shading correction of a reading result of the original obtained by the reader through use of the shading correction data.

3. The image reading apparatus according to claim 2, wherein the at least one processor is configured to detect the abnormal pixel based on second data obtained by performing, through use of first data obtained from a reading result obtained by causing the reader to read a first position outside of the second region of the reference member, the shading correction of the first reading result obtained by causing the reader to read the different positions of the second region of the reference member a plurality of times.

4. The image reading apparatus according to claim 3, wherein the at least one processor is configured to detect the abnormal pixel by comparing the second data and the predetermined threshold value with each other, the predetermined threshold value being an average value of reading results of pixels in a reading result obtained by causing the reader to read the inside of the second region of the reference member a plurality of times.

5. The image reading apparatus according to claim 4, wherein the at least one processor is configured to divide one line of the reading result obtained by causing the reader to read the inside of the second region of the reference member a plurality of times into a plurality of sections, and set an average value of reading results of pixels in each of the plurality of sections as the predetermined threshold value of the each of the plurality of sections.

6. The image reading apparatus according to claim 2, wherein the at least one processor is configured to generate the shading correction data by correcting the abnormal pixel based on the second reading result of a pixel adjacent to the abnormal pixel in a direction of one line.

7. The image reading apparatus according to claim 2, wherein the at least one processor is configured to detect the abnormal pixel in response to acquisition of an instruction to start reading of the original, and correct the abnormal pixel after the abnormal pixel is detected.

8. The image reading apparatus according to claim 2, wherein the at least one processor is configured to detect the abnormal pixel before an instruction to start reading of the original is acquired, and correct the abnormal pixel after the instruction to start reading is acquired.

9. The image reading apparatus according to claim 8, wherein the at least one processor is configured to detect the abnormal pixel in a case where the image reading apparatus is started up.

10. The image reading apparatus according to claim 8, further comprising:
a placement portion on which the original is to be placed; and
an original detection sensor configured to detect the original placed on the placement portion,
wherein the at least one processor is configured to detect the abnormal pixel in a case where the original detection sensor detects the original.

11. The image reading apparatus according to claim 10,
wherein the placement portion is a tray provided in a conveyance portion configured to convey the original to a reading position of the reader, and
wherein the original detection sensor is configured to detect the original placed on the tray.

12. The image reading apparatus according to claim 10,
wherein the placement portion is a platen, and
wherein the original detection sensor is configured to detect the original placed on the platen.

13. The image reading apparatus according to claim 10, further comprising a timer configured to count an elapsed time period from previous detection of the abnormal pixel,
wherein the at least one processor is configured to detect the abnormal pixel in a case where the original detection sensor detects the original and a predetermined time period has elapsed from the previous detection of the abnormal pixel.

14. The image reading apparatus according to claim 2, wherein the at least one processor is configured to detect the abnormal pixel before an instruction to start reading of the original is acquired, and correct the abnormal pixel before the instruction to start reading is acquired.

15. The image reading apparatus according to claim 14, further comprising:
a placement portion on which the original is to be placed; and
an original detection sensor configured to detect the original placed on the placement portion,
wherein the at least one processor is configured to detect the abnormal pixel in a case where the original detection sensor detects the original, and correct the abnormal pixel after the abnormal pixel is detected.

16. The image reading apparatus according to claim 15, further comprising a timer configured to count an elapsed time period from previous detection of the abnormal pixel,
wherein the at least one processor is configured to detect the abnormal pixel again in a case where a predetermined time period has elapsed from the previous detection of the abnormal pixel and an instruction to start reading of the original is acquired, and
wherein the at least one processor is configured to correct the abnormal pixel again in a case where the predetermined time period has elapsed from the previous detection of the abnormal pixel and the instruction to start reading of the original is acquired.

17. The image reading apparatus according to claim 15, further comprising a timer configured to count an elapsed time period from previous detection of the abnormal pixel, wherein the at least one processor is configured to correct the abnormal pixel again in a case where a predetermined time period has elapsed from previous correction of the abnormal pixel and an instruction to start reading of the original is acquired.

18. An image forming system comprising:
an image reading apparatus; and
an image forming apparatus configured to form an image onto a sheet based on image data generated by performing shading correction of a reading result of the original by the image reading apparatus,
wherein the image reading apparatus includes:
a reference member;
a reader configured to read one of an original or the reference member;
a mover configured to move the reader to a first region in which the original is read and a second region in which the reference member is read in a conveying direction of the original; and
at least one processor configured to perform the shading correction, and
wherein the at least one processor is configured to:
control the reader to move from outside of the second region to inside of the second region in the conveying direction to perform a first reading operation of reading the reference member within the second region;
control the reader to move, after the first reading operation is performed, from the outside of the second region to the inside of the second region again and cause the reader to perform a second reading operation of reading the reference member within the second region; and
perform the shading correction using a first reading result read in the first reading operation and a second reading result read in the second reading operation.
